(19) United States
(12) Patent Application Publication
(10) Pub. No.: US 2008/0082700 A1
(43) Pub. Date: Apr. 3, 2008

(54) INTERRUPT PROCESSING METHOD

(75) Inventor: Yuichi OGAWA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/742,127

(22) Filed: Apr. 30, 2007

(30) Foreign Application Priority Data
Sep. 28, 2006 (JP) 2006-263783

(51) Int. Cl. G06F 3/00

(52) U.S. Cl. 710/5

(57) ABSTRACT

In order to provide an interrupt processing method capable of improving an I/O response, and the number of times of I/O processing, of an interrupt target apparatus, an apparatus control unit 101 determines an interrupt processing method based on a load of the unit itself and stores the determined interrupt processing method as interrupt control information. A peripheral apparatus control unit 102, having received an execution request from the apparatus control unit 101, reads an instruction from an instruction storage unit 103 and executes the instruction, performs an interrupt on the apparatus control unit 101 by the interrupt processing method based on the interrupt control information and notifies of a completion.

### BACKGROUND OF THE INVENTION

1. Field of the Invention

The present invention relates to an interrupt processing method for a peripheral device to a CPU (Central Processing Unit).

2. Description of the Related Art

A use of interrupt processing is an essential technique for an information processing apparatus and its built-in hardware. In the case of a CPU making a peripheral device carry out a desired process for example, an interrupt process is utilized for controlling the peripheral device effectively.

FIG. 1 is a diagram exemplifying a common configuration in the case of performing a DMA (Direct Memory Access) transfer.

A CPU 901 write an executing instruction to memory 902 and also requests a DMA engine (abbreviated as “DMA” hereinafter) 903 for executing the instruction. This prompts the DMA 903 to read a prescribed instruction from the memory 902 in compliance with the request from the CPU 901 and execute the instruction.

Upon completion of the execution, the DMA 903 performs interrupt processing on the CPU 901, thereby notifying it of the event of completing the execution of the instruction.

An interrupt processing has conventionally been performed as follows.

FIG. 2 is a diagram describing a conventional example of interrupt processing.

(1) As the CPU 901 requests the DMA 903 for executing an instruction, (2) the DMA 903 reads a prescribed instruction from the memory 902 and executes the instruction, and (3) performs interrupt processing on the CPU 901 to notify it of the event of completing the execution of the instruction. The steps (4) through (9) are similar. The interrupt processing described above is called “instant interrupt processing” hereinafter.

Meanwhile, there is a case of using interrupt processing as shown in the following.

FIG. 3 is a diagram describing a conventional example of interrupt processing different from FIG. 2.

(1) As the CPU 901 requests the DMA 903 for executing an instruction-1, (2) the DMA 903 reads a prescribed instruction-1 from the memory 902 and executes the instruction-1, in the event of which (3) the DMA 903 refrains from performing interrupt processing (i.e., a completion notification process) for a certain time after completing the execution of the instruction-1. Then, it performs interrupt processing on the CPU 901 to notify it of the completion after the certain time elapses.

(4) The CPU 901 likewise requests the DMA 903 for executing an instruction-2, (5) the DMA 903 pauses interrupt processing (i.e., a completion notification process) for a certain time after completing the execution of the instruction-2. (6) The CPU 901 further requests the DMA 903 for executing an instruction-3, then (7) the DMA 903 executed the instruction-3 without notifying of the completion of the instruction-2. (8) In another predetermined time, the DMA 903 performs interrupt processing on the CPU 901 to notify it of the completion of the instructions (i.e., the instructions-2 and -3) executed in the certain time. The interrupt processing described above is called “delayed interrupt processing” hereinafter.

In the case of employing the apparatus shown in FIG. 1 for a control apparatus of a disk array apparatus for example, a use of the instant interrupt processing is advantageous in order to improve a response time for the CPU 901 executing an input/output (I/O) instruction from a host computer (named as “I/O response” hereinafter). This, however, increases a load on the CPU 901, reducing the number of times of I/O instructions processible by the CPU 901 in a certain time (named as “the number of times of I/O processing” hereinafter).

Comparably, a use of the delayed interrupt processing is advantageous in order to improve the number of times of I/O processing; an I/O response is decreased, however, because the timing for interrupting is limited.

A Laid-Open Japanese Patent Application Publication No. H02-041548 has disclosed an I/O interrupt control system for stopping interrupt processing until a CPU issues an interrupt reception notification after an interrupt thereto. And a Laid-Open Japanese Patent Application Publication No. 2002-023961 has disclosed an interrupt execution method for executing instant interrupt processing and delayed interrupt processing selectively in accordance with a category of a command or a usage condition of cache memory.

### SUMMARY OF THE INVENTION

In consideration of the problem described above, the issues to be solved by the present invention is to provide an interrupt processing method capable of improving an I/O response and the number of times of I/O processing at an interrupt target apparatus.

In order to solve the issues, an interrupt processing method according to the present invention is one for use in an information processing apparatus comprising a peripheral apparatus control unit performing input/output processing of data from and to a peripheral apparatus and an apparatus control unit making the peripheral apparatus control unit execute a discretionary instruction, wherein the apparatus control unit stores a desired instruction in an instruction storage unit, requests the peripheral apparatus control unit for executing the instruction, determines an interrupt processing method based on a load state of the unit itself and stores the determined method as interrupt control information in an interrupt control information storage unit, and the peripheral apparatus control unit executes the instruction in accordance with a request from the apparatus control unit and performs interrupt processing for notifying the apparatus control unit of a completion of the execution based on the interrupt control information.

The present invention is contrived so that the apparatus control unit determines an interrupt processing method performed to the unit itself based on a load state thereof and stores the method as interrupt control information in the interrupt control information storage unit. Meanwhile, the peripheral apparatus control unit performs interrupt processing on the apparatus control unit in accordance with the interrupt control processing method stored (i.e., set) as the interrupt control information.

Therefore, when a load on the apparatus control unit is low for example, a setup of the interrupt control information so as to perform the instant interrupt processing that performs interrupt processing instantly improves a time (e.g., an I/O response) for the apparatus control unit to obtain a notification of a completion of an execution from the peripheral apparatus control unit.

Comparably, when a load on the apparatus control unit is high, a setup of the interrupt control information so as to perform the delayed interrupt processing that refrains from performing interrupt processing until a certain time elapses improves the number of times of instruction (e.g., the number of times of I/O processing) to the peripheral apparatus control unit from the apparatus control unit because of reducing a load on the apparatus control unit.

As described above, the present invention enables a provision of an interrupt processing method capable of simultaneously improving an I/O response, and the number of times of I/O processing, of an interrupt target apparatus.

### BRIEF DESCRIPTION OF THE DRAWINGS

FIG. 1 is a diagram exemplifying a common configuration in the case of performing a DMA transfer;

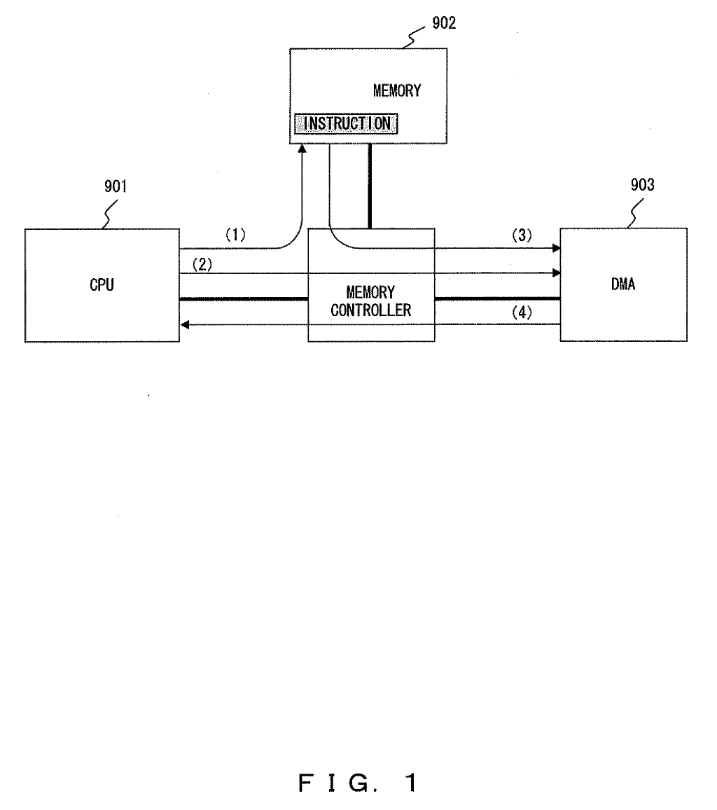

FIG. 2 is a diagram describing a conventional example of interrupt processing;

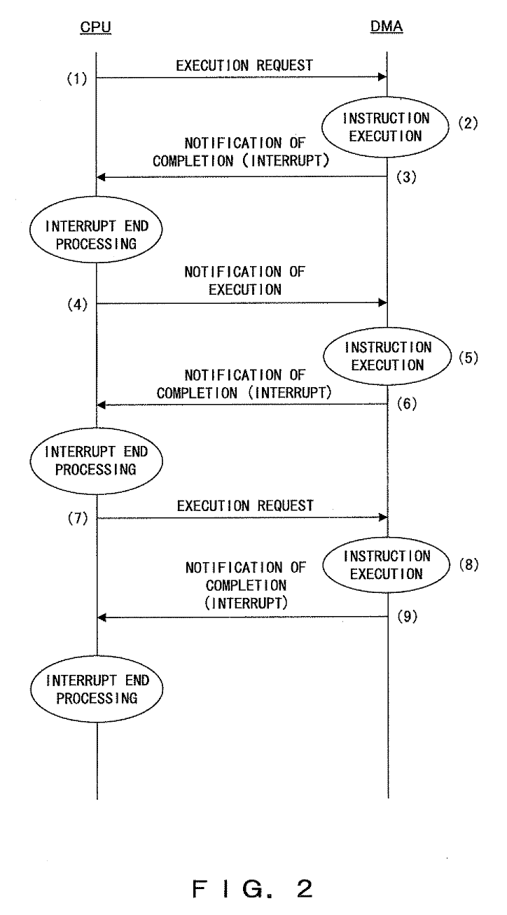

FIG. 3 is a diagram describing a conventional example of interrupt processing different from FIG. 2;

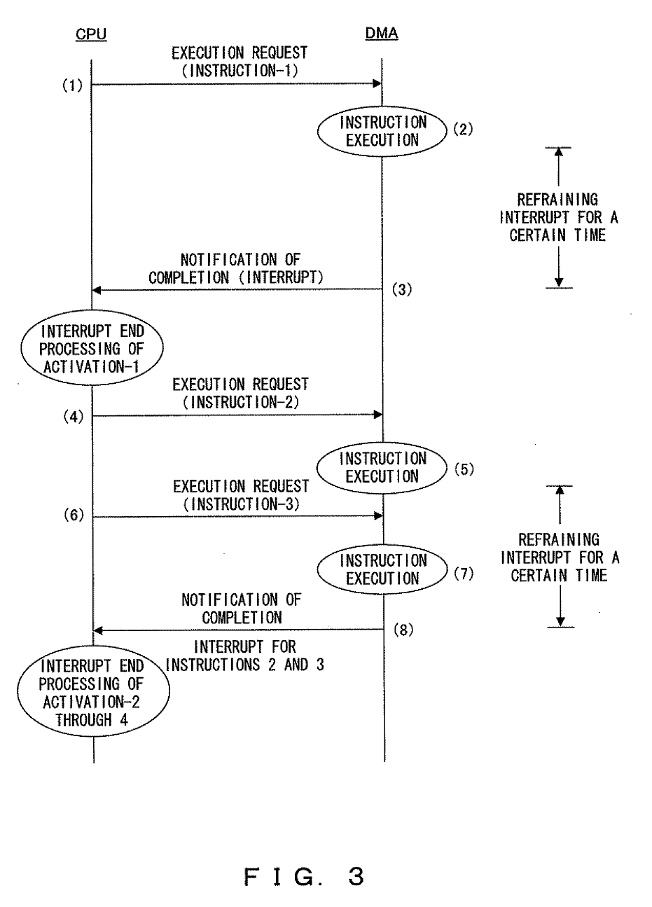

FIG. 4 is a diagram describing the principle of operation of a disk array control apparatus employing an interrupt processing method according to a preferred embodiment of the present invention;

FIG. 5 is a diagram exemplifying an overall configuration of a disk array system employing an interrupt processing method according to a preferred embodiment of the present invention;

FIG. 6 is a diagram exemplifying a specific configuration of a CM according to a preferred embodiment of the present invention;

FIG. 7 is a diagram describing an outline of DMA transfer processing employing an interrupt processing method according to a preferred embodiment of the present invention;

FIG. 8 is a diagram exemplifying a structure of an instruction executed by a DMA according to a preferred embodiment of the present invention;

FIG. 9 is a diagram describing an outline of interrupt processing according to a preferred embodiment of the present invention;

FIG. 10 is a flow chart showing specific processing of an instruction execution unit according to a preferred embodiment of the present invention; and

FIG. 11 is a flow chart showing specific processing of an interrupt control unit according to a preferred embodiment of the present invention.

### DESCRIPTION OF THE PREFERRED EMBODIMENTS

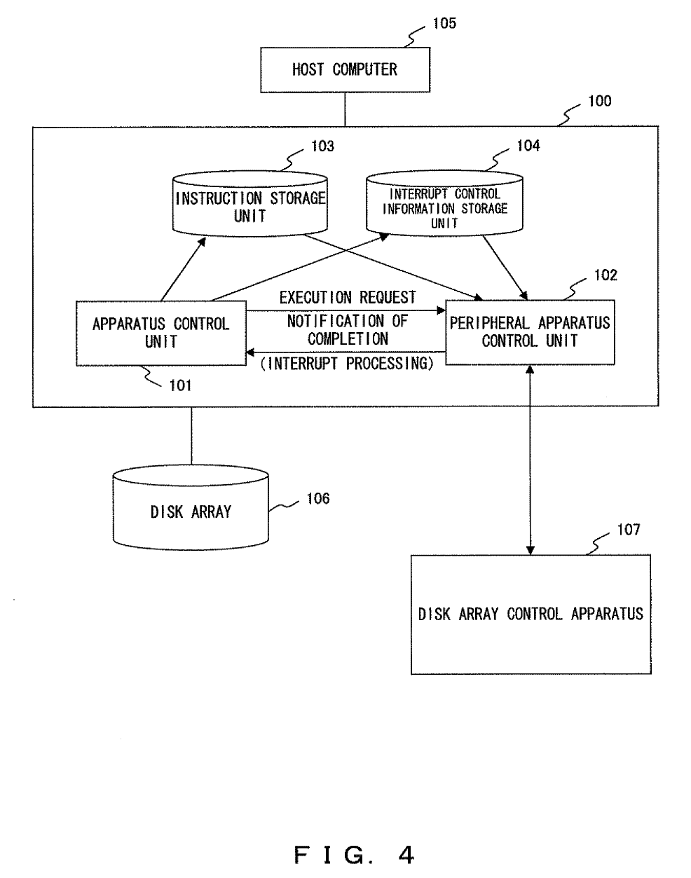

The following is a description of the preferred embodiment of the present invention by referring to FIGS. 4 through 11.

FIG. 4 is a diagram describing the principle of operation of a disk array control apparatus 100 employing an interrupt processing method according to a preferred embodiment of the present invention.

The disk array control apparatus 100 shown by FIG. 4 processes reading and writing data from and to a disk array 106 based on a request from a host computer 105. The disk array control apparatus 100 also carries out a data transmission and reception to and from another disk array control apparatus 107, including a data transmission and reception by such as synchronization processing of data in the case of a disk array apparatus being multiplexed for example.

The disk array control apparatus 100 according to the present embodiment comprises at least an apparatus control unit 101 for controlling the entirety of the apparatus, a peripheral apparatus control unit 102 for carrying out a data transmission and reception to and from another disk array control apparatus 107 based on a request of the apparatus control unit 101, an instruction storage unit 103 for storing an execution instruction and data at the time of carrying out a disk cache, and an interrupt control information storage unit 104 for storing interrupt control information.

The apparatus control unit 101 carries out data reading and writing processing from and to the disk array 106 based on a request from the host computer 105.

The apparatus control unit 101 also makes the peripheral apparatus control unit 102 carry out a data transmission and reception to and from another disk array control apparatus 107. In this event, the apparatus control unit 101 writes an instruction to be executed to an instruction storage unit 103, followed by requesting the peripheral apparatus control unit 102 for executing the instruction.

Simultaneously, the apparatus control unit 101 determines an interrupt processing method performed on the unit itself based on a load state thereof, and stores the determined interrupt processing method as interrupt control information in the interrupt control information storage unit 104.

The peripheral apparatus control unit 102, having received a request for an execution from the apparatus control unit 101, reads an instruction from the instruction storage unit 103 and executes the instruction and carries out a data transmission and reception to and from another disk array control apparatus 107, for example, and such. Then, upon completion of the execution of the instruction, carries out interrupt processing on the apparatus control unit 101 for a notification of the completion.

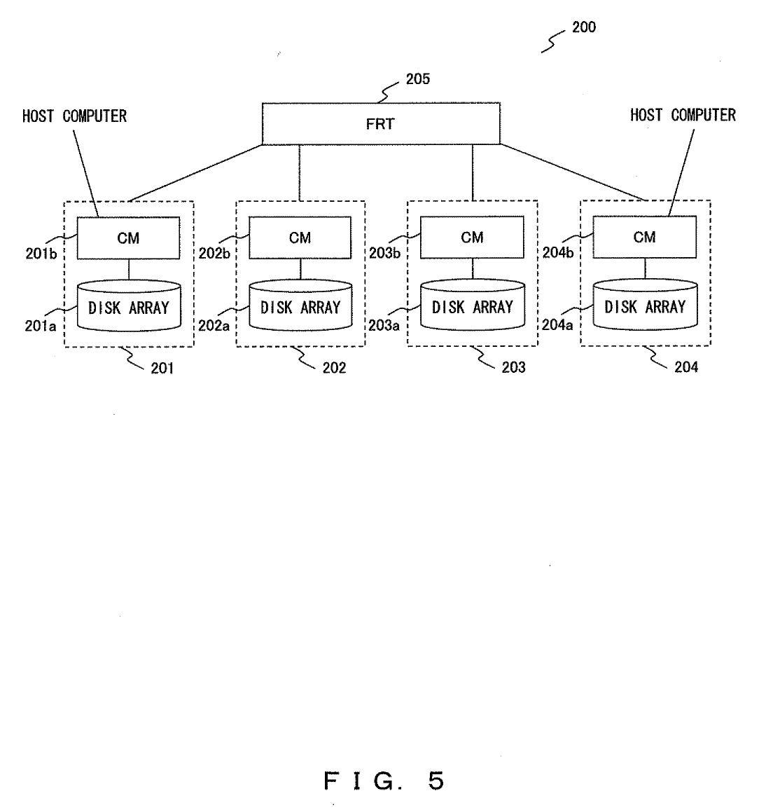

FIG. 5 is a diagram exemplifying an overall configuration of a disk array system employing an interrupt processing method according to a preferred embodiment of the present invention.

As shown in FIG. 5, the disk array system 200 comprises disk array apparatuses 201 through 204 constituting a Redundant Arrays of Inexpensive Disks (RAID) and such, and a Front end Router (FRT) 205 communicably interconnecting each disk array apparatus.

The disk array apparatus 201 comprises a disk array 201a constituted by one or two or more disks, and a Controller Module (CM) 201b for data reading and writing from and to the disk array 201a.

Likewise, the disk array apparatuses 202 through 204 respectively comprise disk arrays 202a, 203a and 204a; and CM 202b, CM 203b and CM 204b.

Meanwhile, the disk array apparatuses 201 and 204 are connected to the host computers respectively.

Having received a READ instruction for example from the host computer, the CM 201b reads applicable data from the disk array 201a and transmits it to the host computer.

Having received a WRITE instruction, the CM 201b writes, to disk array 201a, the data received from the host computer. Furthermore, if the disk array apparatuses 201 and 202 constitute a duplex, the CM 201b transmits data to the disk array apparatus 202. Having received the data, the CM 202b stores it in the disk array 202a. A similar process is carried out in the disk array apparatuses 203 and 204.

Note that FIG. 5 exemplifies the case of four disk array apparatuses and CMs; the shown configuration is apparently discretionary, however.

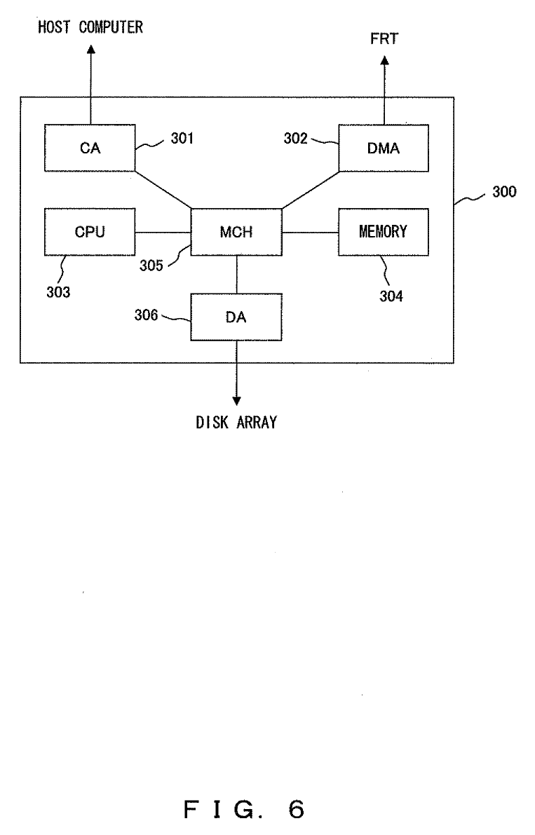

FIG. 6 is a diagram exemplifying a specific configuration of a CM 300 according to a preferred embodiment of the present invention.

As shown in FIG. 6, the CM 300 comprises a Channel Adaptor (CA) 301 that is an interface for connecting to a host computer; a DMA engine (abbreviated as “DMA” hereinafter) 302 for communicating with another CM by means of a Direct Memory Access (DMA); a CPU 303 for reading and writing data in compliance with an instruction from the host computer; memory 304 used as a disk cache and memory for control; a Memory Controller (NCH) 305 for controlling the memory 304; and a Device Adaptor (DA) 306 that is an adaptor for controlling a disk array.

In the case of transferring data between disk array apparatuses, the DMA 302 reads an instruction (e.g., a READ or WRITE instruction) stored in a predetermined position of the memory 304 and execute the instruction based on a request from the CPU 303.

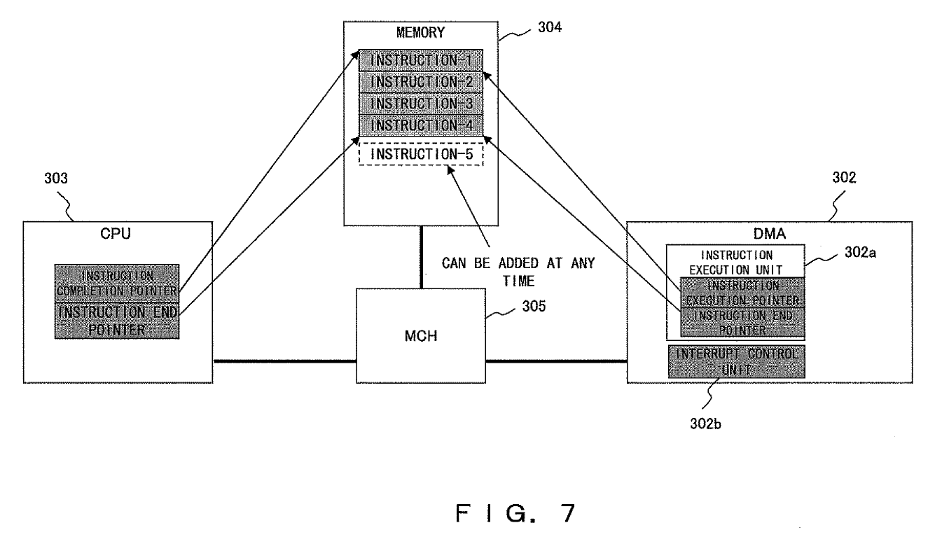

FIG. 7 is a diagram describing an outline of DMA transfer processing employing an interrupt processing method according to the present invention.

The DMA 302 comprises an instruction execution unit 302a for executing an instruction in compliance with a request from the CPU 303, and an interrupt control unit 302b for controlling an interrupt to the CPU 303.

The instruction execution unit 302a retains an instruction execution pointer and an instruction end pointer, both of which store an address of the instruction continuously written to the memory 304, with the instruction execution pointer storing the address of the initial instruction to be executed and the instruction end pointer storing the address of the instruction at the tail end of the continuous instruction.

The DMA 302 also executes an instruction starting from one indicated by the instruction execution pointer sequentially to the one indicated by the instruction end pointer.

The CPU 303 retains an instruction completion pointer and an instruction end pointer, both of which store the address of an instruction continuously written to the memory 304, with the instruction completion pointer storing the address of the previously executed instruction, and the instruction end pointer storing the address of the instruction at the tail end of a list.

In the case of carrying out a DMA transfer between CMs, the CPU 303 writes an instruction to be executed by the DMA 302 to the memory 304 (i.e., adds at the end of the instruction) and also updates an instruction end pointer. The example 4 shown in FIG. 7 shows the case of writing the instructions-2, -3 and -4 to the memory 304. Therefore, the address of the instructional is set to the instruction completion pointer and the address of the instruction-4 is set to the instruction end pointer in this case.

Having written a desired instruction to the memory 304, the CPU 303 requests the DMA 302 for an execution of the instruction. In this event, the instruction end pointer retained by the DMA 302 is also updated. In the example shown in FIG. 7, the address of the instruction-4 is set to the instruction end pointer.

Having received the execution request of the instruction from the CPU 303, the DMA 302 starts an execution of the instruction. First, the DMA 302 reads an instruction of an address indicated by the instruction execution pointer from the memory 304 and executes the instruction, i.e., the instruction-2 according to the example shown in FIG. 7.

Upon completing the execution of the instruction, the DMA 302 refers to an interrupt control flag of the present instruction and, if the interrupt control flag is set to Off, the DMA 302 carries out an interrupt to the CPU 303 for notifying the completion of the execution of the instruction. Then, it updates the instruction execution pointer and reads the next instruction. In the example of FIG. 7, it increments the instruction execution pointer only by one instruction and reads the instructions.

Meanwhile, having received the notification of the execution completion from the DMA 302, the CPU 303 updates the instruction completion pointer, that is, increments it by one instruction and set to the address of the instruction-3.

If the interrupt control flag of the present instruction is set to On, the DMA 302 updates the instruction execution pointer and reads the next instruction without carrying out an interrupt to the CPU 303 (i.e., without notifying the CPU 303 of an completion of executing the instruction).

The DMA 302 carries out the process described above until the instruction execution pointer matches with an instruction end pointer.

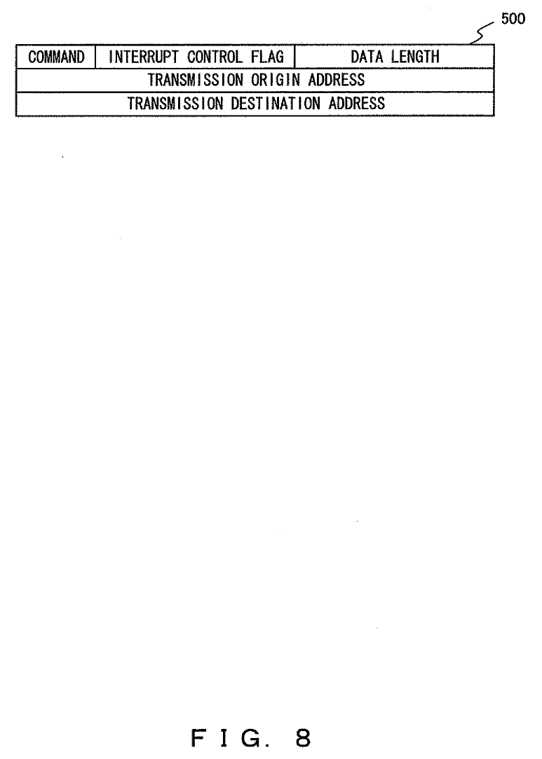

FIG. 8 is a diagram exemplifying a structure of an instruction executed by the DMA 302 according to a preferred embodiment of the present invention.

The instruction 500 shown by FIG. 8 is structured by a command, an interrupt control flag, a data length, a transfer origin address and a transfer destination address.

The command is a category of an instruction (i.e., processing content) such as READ and WRITE. The interrupt control flag set by the CPU 303 based on a load state of the CPU itself, and the like, is one for controlling interrupt processing performed on the CPU 303.

The present embodiment is configured to check a processing condition in a prescribed sampling interval (e.g., one millisecond), judge to be a Busy state if the CPU 303 is in a kind of processing for example, and an Idle state if it is not in processing. And the case of Busy state is counted (a count value in this event is named as “Busy count value”) so as to calculate a Busy ratio by the following expression:

(Busy ratio)=(Busy count value/Total sampling number)*100 (%)

If the Busy ratio exceeds a 70%, the load is judged to be high and the interrupt control flag is accordingly set to On. Note that the present embodiment is configured to use a 70% for the threshold value of the Busy ratio; it is of course discretionary, however, and an appropriate value may be set as a threshold value.

The data length indicates a size of data to be processed based on a command. The transfer origin address indicates a head address where data to be transferred is stored, and the transfer destination address indicates a head address for data to be transferred to and stored therein.

The DMA 302 changes over a method of interrupt processing on the CPU 303 based on a setting to On or Off of an interrupt control flag. That is, if the interrupt control flag is set to On, the delayed interrupt processing is performed, while if the interrupt control flag is set to Off, the instant interrupt processing is performed.

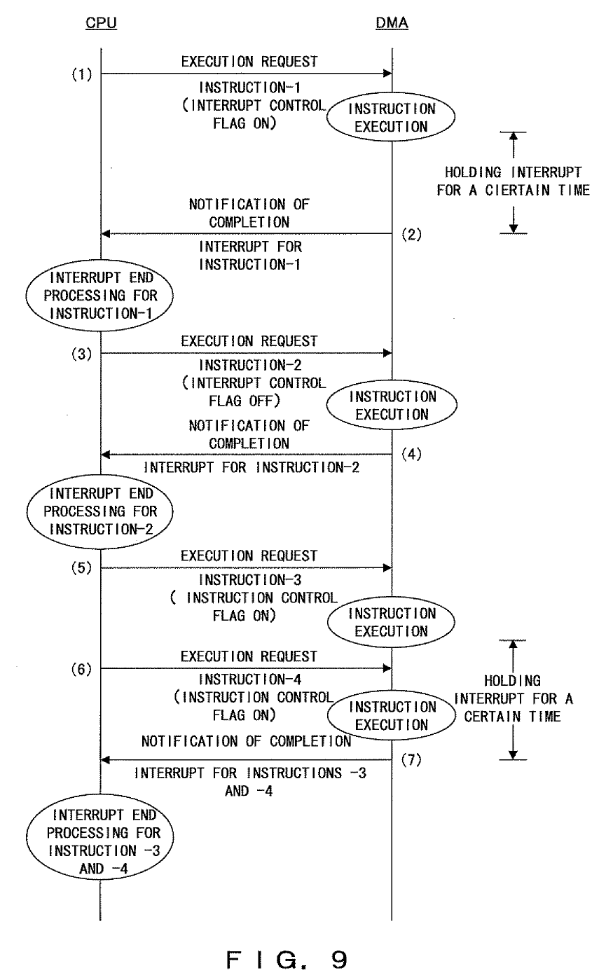

FIG. 9 is a diagram describing an outline of interrupt processing according to a preferred embodiment of the present invention.

(1) If a load on the CPU 303 is large, the CPU 303 writes an instructional setting the interrupt control flag to On to the memory 304, and requests the DMA 302 for an execution.

(2) Having received the execution request from the CPU 303, the DMA 302 reads the instruction-1 from the memory 304 and executes the instruction. And, since the interrupt control flag of the present instruction is set to On, the DMA 302 refrains from carrying out interrupt processing on the CPU 303 until a certain time elapses after the instruction is executed, followed by carrying out interrupt processing on the CPU 303 after the certain time elapses, and notifying of the completion.

(3) If the load on the CPU 303 is small, the CPU 303 writes an instruction-2 setting the interrupt control flag to Off to the memory 304, and requests the DMA 302 for an execution.

(4) Having received the execution request from the CPU 303, the DMA 302 reads the instruction-2 from the memory 304 and executes the instruction. And, since the interrupt control flag of the present instruction is set to Off, the DMA 302 carries out interrupt processing on the CPU 303 immediately after the instruction is executed and notifies of the completion.

(5) Likewise the above paragraph (1), when the CPU 303 writes an instruction-3 setting the interrupt control flag to On to the memory 304 and requests the DMA 302 for an execution, the DMA 302 reads the instruction-3 from the memory 304 and executes the instruction. In this event, the interrupt control flag of the present instruction is set to On, the DMA 302 refrains from carrying out interrupt processing on the CPU 303 until a certain time elapses.

(6) Furthermore as the above paragraph (1), when the CPU 303 writes an instruction-4 setting the interrupt control flag to On to the memory 304 and requests the DMA 302 for an execution, the DMA 302 executes the instruction-4 without notifying of the completion of the instruction-3.

(7) The DMA 302 carries out interrupt processing on the CPU 303 after the certain time has elapsed and notifies of the completion of the instructions (i.e., the instructions-3 and -4) executed within the present certain time.

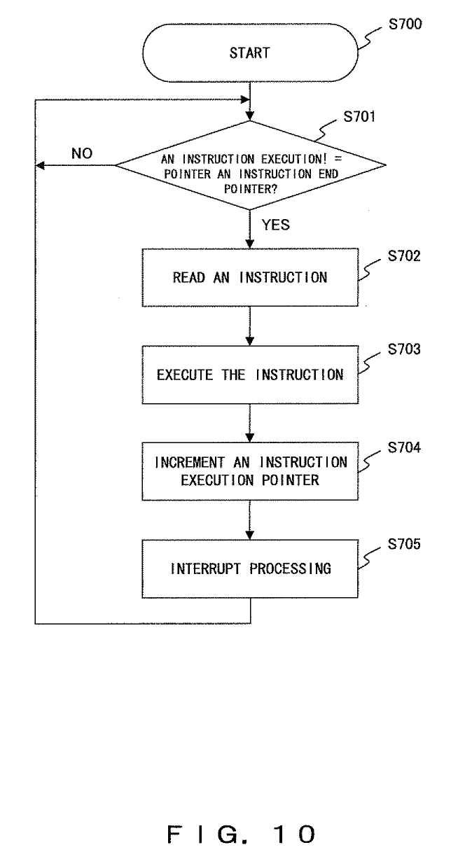

FIG. 10 is a flow chart showing specific processing of the instruction execution unit 302a according to a preferred embodiment of the present invention.

Having received a request for execution from the CPU 303, the instruction execution unit 302a shifts the process to the step S701 in which the instruction execution unit 302a reads an instruction execution pointer and an instruction end pointer from an internally comprised register for example. Then it compares the addresses of both of the pointers. If both pointers are identical as a result of the comparison, the instruction execution unit 302a judges that there is no instruction to be executed, and shifts the process to the step S701.

Contrarily, if both pointers are not identical as a result of comparison in the step S701, it judges that there is an instruction to be executed, and shifts the process to the step S702.

In the step S702, the instruction execution unit 302a reads an instruction from the address in the memory 304 indicated by the instruction execution pointer, followed by shifting the process to the step S703 and executing the present instruction.

Upon completing an execution of the instruction, the instruction execution unit 302a shifts the process to the step S704. And the instruction execution unit 302a increments the instruction execution pointer by only one (“1”) (i.e., by one instruction sentence).

Upon completion of the execution of one instruction by the above described process, the instruction execution unit 302a shifts the process to the step S705. It then requests the interrupt control unit 302b to carry out interrupt processing for notifying the CPU 303 of the completion,

Upon completion of the processes described above, the instruction execution unit 302a shifts the process to the step S701 and carries out the processes of the steps S701 through S705 until the execution of all instructions completes.

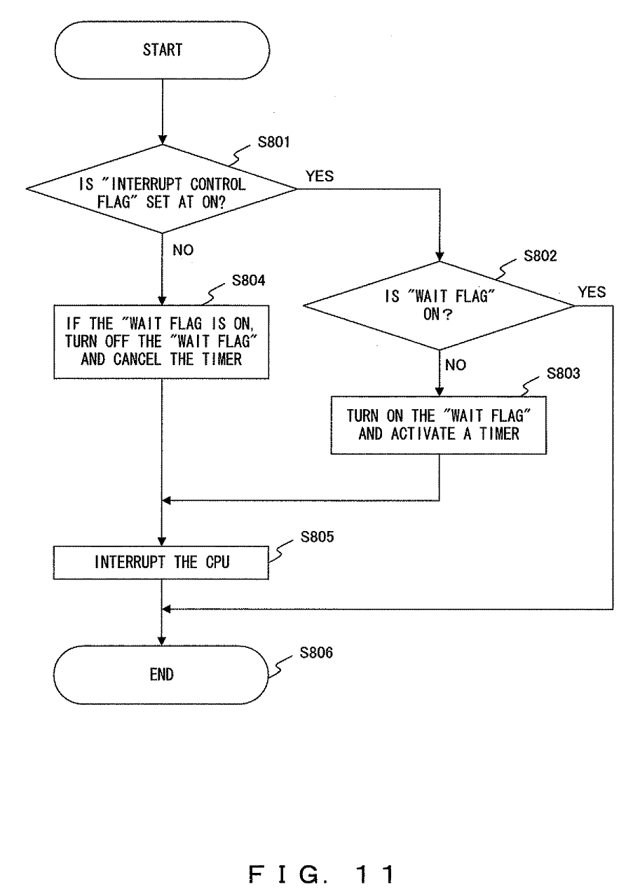

FIG. 11 is a flow chart showing specific processing of the interrupt control unit 302b according to a preferred embodiment of the present invention.

In the step S705 shown in FIG. 10, when the instruction execution unit 302a requests the interrupt control unit 302b for a notification of completion by interrupt processing, the interrupt control unit 302b shifts the process to the step S801.

In the step S801, the interrupt control unit 302b checks an interrupt control flag of the instruction executed in the step S703 shown in FIG. 10. If the interrupt control flag indicates an On, it shifts the process to the step S802.

In the step S802, the interrupt control unit 302b reads a wait flag provided in a register or such (simply named as “wait flag” hereinafter) in the inside of the DMA 302, and check the wait flag. Note that the wait flag is one for indicating a presence or absence of a timer function, indicating that a timer is in activation if the wait flag is set to On.

If the wait flag is set to On in the step S802, the interrupt control unit 302b shifts the process to the step S806 and ends the process without carrying out interrupt processing.

Contrarily, if the wait flag is set to Off in the step S802, the interrupt control unit 302b shifts the process to the step S803. Then it sets the wait flag to On and activates a timer at the same time for shifting to a standby (i.e., a sleep) state for a certain time.

In this state, if the interrupt control unit 302b (i.e., a process) is further called up by the instruction execution unit 302a, the present interrupt control unit 302b shifts the process to the step S806 from the S802, and ends the process.

Upon returning from a standby state after a certain time elapses by means of the timer function, the interrupt control unit 302b shifts the process to the step S805, and carries out interrupt processing on the CPU 303 for a notification of a completion of the instruction, followed by shifting the process to the step S803 and ending the process.

Meanwhile, if the interrupt control flag indicates an Off in the step S801, the interrupt control unit 302b shifts the process to the step S804.

In the step S804, the interrupt control unit 302b reads the wait flag. If the wait flag is set to On, it turns Off the present wait flag and simultaneously cancels the timer, followed by shifting the process to the step S805.

In the step S805, the interrupt control unit 302b carries out interrupt processing on the CPU 303 for a notification of completing the instruction of the step S703 shown in FIG. 10, followed by shifting the process to the step S806 and ending the process.

Here, the embodiment described above has described the case of applying the interrupt processing method of the present embodiment to the disk array control apparatus 100; the similar effect can be obtained, however, by an application to an apparatus using interrupt processing in the case of a CPU controlling a peripheral apparatus such as an information processing apparatus for example.

As described above, the disk array control apparatus 100 according to the present embodiment is configured such that the CPU 303 stores (i.e., sets) an interrupt processing method based on a load state of the CPU 302 itself as interrupt control information in the interrupt control information storage unit 104 and the DMA 302 carries out interrupt processing on the CPU 303 by using the interrupt processing method set up as the interrupt control information.

If a Busy ratio is low, setting the instant interrupt processing in the interrupt control information makes it possible to complete one I/O processing quickly, enabling an improvement of an I/O response.

Contrarily, if the Busy ratio is high, setting the delayed interrupt processing in the interrupt control information makes it possible to complete a plurality of interrupt processing within a single time of interrupt processing, thus reducing a load on the CPU 303 and improving the number of times of I/O processing in the CPU 303.

As a result, what is realized is a benefit of enabling an improvement in the performance of an I/O response and of the number of times of I/O processing at the same time.

What is claimed is:

1. An interrupt processing method for use in an information processing apparatus comprising a peripheral apparatus control unit performing input/output processing of data from and to a peripheral apparatus and an apparatus control unit making the peripheral apparatus control unit execute a discretionary instruction, wherein
the apparatus control unit stores a desired instruction in an instruction storage unit, requests the peripheral apparatus control unit for executing the instruction, determines an interrupt processing method based on a load state of the unit itself and stores the determined method as interrupt control information in an interrupt control information storage unit, and
the peripheral apparatus control unit executes the instruction in accordance with a request from the apparatus control unit and performs interrupt processing for notifying the apparatus control unit of a completion of the execution based on the interrupt control information.

2. The interrupt processing method according to claim 1,
determining either of a method of instant interrupt processing for performing interrupt processing on the instant said instruction is completed or of delayed interrupt processing for refraining from performing interrupt processing until a certain time elapses after the instruction is completed based on said load.

3. The interrupt processing method according to claim 1,
calculating a busy ratio by monitoring a processing condition of said apparatus control unit itself in a prescribed sampling interval, determining instant interrupt processing if the busy ratio is equal to or lower than a predefined value, and setting delayed interrupt processing if the busy ratio is equal to or higher than a predefined value.

4. An information processing apparatus, comprising:
an apparatus control unit for storing a desired instruction in an instruction storage unit, requesting for executing the instruction, determining an interrupt processing method based on a load state of the unit itself and storing the determined method as interrupt control information in an interrupt control information storage unit, and
a peripheral apparatus control unit for executing the instruction in accordance with a request from the apparatus control unit and performing interrupt processing for notifying the apparatus control unit of a completion of the execution based on the interrupt control information.

5. The information processing apparatus according to claim 4; wherein
said apparatus control unit determines either of a method of instant interrupt processing for performing interrupt processing on the instant said instruction is completed or of delayed interrupt processing for refraining from performing interrupt processing until a certain time elapses after the instruction is completed based on said load.

6. The information processing apparatus according to claim 4, wherein
said apparatus control unit calculates a Busy ratio by monitoring a processing condition of the unit itself in a prescribed sampling interval, determines instant interrupt processing if the Busy ratio is equal to or lower than a predefined value, and sets delayed interrupt processing if the Busy ratio is equal to or higher than a predefined value.

7. A disk array control apparatus which is one for controlling one or two or more disk arrays and which is capable of transmitting and receiving data to and from another disk array control apparatus, comprising:
an apparatus control unit for storing an instruction in an instruction storage unit in accordance with a request from a host computer, requesting for executing the instruction, determining an interrupt processing method based on a load state of the unit itself and storing the determined method as interrupt control information in an interrupt control information storage unit, and
a peripheral apparatus control unit for carrying out a transmission and reception of data to and from the other disk array apparatus by executing the instruction in accordance with a request from the apparatus control unit and performing interrupt processing for notifying the apparatus control unit of a completion of the execution based on the interrupt control information.

8. The disk array control apparatus according to claim 7, wherein
said apparatus control unit determines either of a method of instant interrupt processing for performing interrupt processing on the instant said instruction is completed or of delayed interrupt processing for refraining from performing interrupt processing until a certain time elapses after the instruction is completed based on said load.

9. The disk array control apparatus according to claim 7, wherein
said apparatus control unit calculates a Busy ratio by monitoring a processing condition of the unit itself in a prescribed sampling interval, determines instant interrupt processing if the Busy ratio is equal to or lower than a predefined value, and sets delayed interrupt processing if the Busy ratio is equal to or higher than a predefined value.
